(19) United States
(12) Patent Application Publication
(10) Pub. No.: US 2020/0265787 A1
(43) Pub. Date: Aug. 20, 2020

(54) DISPLAY PANEL DRIVING DEVICE AND DISPLAY DEVICE HAVING THE SAME

(71) Applicant: Samsung Display Co., Ltd., Yongin-Si (KR)

(72) Inventors: Taegon IM, Gwangmyeong-si (KR); Sooyeon KIM, Namyangju-si (KR); Dongwon PARK, Seongnam-si (KR); Jae-Han LEE, Hwaseong-si (KR); Jung Hwan CHO, Asan-si (KR)

(21) Appl. No.: 16/709,068

(22) Filed: Dec. 10, 2019

(30) Foreign Application Priority Data
Feb. 20, 2019 (KR) 10-2019-0019666

(51) Int. Cl. G09G 3/3291; G09G 3/36

(52) U.S. Cl. CPC G09G 3/3291; G09G 3/3688; G09G 2300/0833; G09G 2300/0828; G09G 3/3696

(57) ABSTRACT

A display device includes a display panel, a source driver, and an alignment detection circuit. The display panel includes data lines and pads connected to the data lines. The source driver includes output lines connected to the pads to supply a data signal, and a detection circuit to selectively connect a first detection line supplied with a first detection voltage and a second detection line supplied with a second detection voltage to the output lines. The alignment detection circuit includes a detection capacitor connected between the first detection line and the second detection line, and a voltage detection circuit connected to one end of the detection capacitor to detect a voltage of the detection capacitor. The detection circuit connects a (2n−1)-th output line of the output lines to the first detection line, and connects a (2n)-th output line of the output lines to the second detection line.

This application claims priority to Korean Patent Application No. 10-2019-0019666, filed on Feb. 20, 2019, and all the benefits accruing therefrom under 35 U.S.C. § 119, the content of which in its entirety is herein incorporated by reference.

### BACKGROUND

### 1. Field

Exemplary embodiments relate to a display panel driving device and a display device including the display panel driving device.

### 2. Description of the Related Art

Recently, various flat panel display devices with reduced weight and thin thickness compared to a conventional cathode ray tube (“CRT”) display have been developed. Such flat display devices include a liquid crystal display (“LCD”), a field emission display (“FED”), a plasma display panel (“PDP”), and an organic light emitting display (“OLED”).

A display device may include a display panel to display an image, and a display panel driving device to supply a signal to the display panel. A source driver included in the display panel driving device may generate a data signal. The source driver may be bonded to a non-display region of the display panel in a form of an integrated circuit (“IC”) or may be connected to the non-display region of the display panel through a flexible printed circuit board (“FPCB”) or the like.

### SUMMARY

In a display device, when an integrated circuit (“IC”) is misaligned with pads of a display panel, the screen abnormality may occurs or the display panel may be damaged. Accordingly, a technology for detecting whether the display panel is misaligned with the IC has been studied.

Exemplary embodiments provide a display device capable of detecting misalignment between a display panel and a source driver.

Exemplary embodiments provide a display panel driving device capable of detecting misalignment between a display panel and a source driver.

According to an exemplary embodiment, a display device includes a display panel including a plurality of data lines and a plurality of pads connected to the data lines, a source driver including a plurality of output lines connected to the pads, where the source driver supplies a data signal to the pads through the output lines, and a detection circuit which selectively connects a first detection line and a second detection line to the output lines, where the first detection line is supplied with a first detection voltage and the second detection line is supplied with a second detection voltage, and an alignment detection circuit including a detection capacitor connected between the first detection line and the second detection line, and a voltage detection circuit connected to an end of the detection capacitor to detect a voltage of the detection capacitor. In such an embodiment, the detection circuit connects a (2n−1)-th output line of the output lines to the first detection line, and connects a (2n)-th output line of the output lines to the second detection line, where n is a natural number of 1 or greater.

In an exemplary embodiment, the source driver may further include a digital-to-analog converter which converts digital image data into analog image data, and a buffer circuit including a plurality of buffers which generates the data signal based on the analog image data.

In an exemplary embodiment, the detection circuit may include a first switch which connects the output line to the buffer, a first dummy amplifier which supplies the first detection voltage to the first detection line, a second dummy amplifier which supplies the second detection voltage having a voltage level lower than a voltage level of the first detection voltage to the second detection line, a second switch which connects the first detection line to the (2n−1)-th output line, and a third switch which connects the second detection line to the (2n)-th output line.

In an exemplary embodiment, the detection circuit may turn off the first switch and may turn on the second switch and the third switch during an inspection process to detect whether the output lines are misaligned with the pads.

In an exemplary embodiment, the detection circuit may turn on the first switch and may turn off the second switch and the third switch to transfer the data signal to the pads through the output line.

In an exemplary embodiment, the voltage detection circuit may include a comparator which compares the voltage of the detection capacitor with a reference voltage.

In an exemplary embodiment, the display device may further include a timing controller which generates a control signal to control the source driver. In such an embodiment, the voltage detection circuit may output a shutdown signal to shut down the timing controller based on a comparison result between a voltage of the detection capacitor and the reference voltage.

In an exemplary embodiment, the display device may further include a voltage generator which supplies the first detection voltage and the second detection voltage. In such an embodiment, the voltage detection circuit may output a shutdown signal to shut down the voltage generator based on a comparison result between the voltage of the detection capacitor and the reference voltage.

In an exemplary embodiment, an end of the source driver may be connected to the pads of the display panel, and an opposite end of the source driver may be connected to a printed circuit board.

In an exemplary embodiment, the alignment detection circuit may be disposed on the printed circuit board.

According to an exemplary embodiment, a display panel driving device includes a source driver including a plurality of output lines through which a data signal is transmitted, and a detection circuit which selectively connects a first detection line and a second detection line to the output lines, where the first detection line transmits a first detection voltage and a second detection line transmits a second detection voltage, and an alignment detection circuit including a detection capacitor connected between the first detection line and the second detection line, and a voltage detection circuit connected to an end of the detection capacitor, where the voltage detection circuit detects a voltage of the detection capacitor. In such an embodiment, the detection circuit connects a (2n−1)-th output line of the output lines to the first detection line, and may connect a (2n)-th output line of the output lines to the second detection line, where n is a natural number of 1 or greater.

In an exemplary embodiment, the source driver may further include a digital-to-analog converter which converts digital image data into analog image data, and a buffer circuit including a plurality of buffers which generates the data signal based on the analog image data.

In an exemplary embodiment, the detection circuit may include a first switch which connects the output line to the buffer, a first dummy amplifier which supplies the first detection voltage to the first detection line, a second dummy amplifier which supplies the second detection voltage having a voltage level lower than a voltage level of the first detection voltage to the second detection line, a second switch which connects the first detection line to the (2n−1)-th output line, and a third switch which connects the second detection line to the (2n)-th output line.

In an exemplary embodiment, the detection circuit may turn off the first switch and may turn on the second switch and the third switch during an inspection process to detect whether the output lines are misaligned with a plurality of pads of a display panel.

In an exemplary embodiment, the detection circuit may turn on the first switch and may turn off the second switch and the third switch to output the data signal through the output line.

In an exemplary embodiment, the voltage detection circuit may include a comparator which compares the voltage of the detection capacitor with a reference voltage.

In an exemplary embodiment, the display panel driving device may further include a timing controller which generates a control signal to control the source driver. In such an embodiment, the voltage detection circuit may output a shutdown signal to shut down the timing controller based on a comparison result between the voltage of the detection capacitor and the reference voltage.

In an exemplary embodiment, the display panel driving device may further include a voltage generator which supplies the first detection voltage and the second detection voltage. In such an embodiment, the voltage detection circuit may output a shutdown signal to shut down the voltage generator based on a comparison result between the voltage of the detection capacitor and the reference voltage.

In an exemplary embodiment, one end of the source driver may be connected to the pads of the display panel, and an opposite end of the source driver may be connected to a printed circuit board.

In an exemplary embodiment, the alignment detection circuit may be disposed on the printed circuit board.

In exemplary embodiments of the invention, as set forth herein, a display device and a display panel driving device may detect misalignment between pads of a display panel and output lines of a source driver by supplying a first detection voltage to odd-numbered output line through a first detection line, by supplying a second detection voltage to even-numbered output line through a second detection line, and by detecting a voltage of a detection capacitor connected between the first detection line and the second detection line, during an inspection process of the display device. Accordingly, in such embodiment, a bonding defect between the display panel and the source driver may be easily detected.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram illustrating a display device according to an exemplary embodiment;

FIGS. 2A and 2B are diagrams illustrating a display panel and a source driver included in the display device of FIG. 1;

FIG. 3 is a block diagram illustrating a source driver included in the display device of FIG. 1;

FIG. 4 is a diagram illustrating a detection circuit and an alignment detection circuit included in the source driver of FIG. 3;

FIG. 5 is a diagram illustrating an exemplary embodiment of the alignment detection circuit of FIG. 4; and

FIGS. 6A to 6C are diagrams for describing operations of the detection circuit and the alignment detection circuit of FIG. 4.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” “At least one of A and B” means “A and/or B.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Hereinafter, embodiments of the invention will be described in detail with reference to the accompanying drawings.

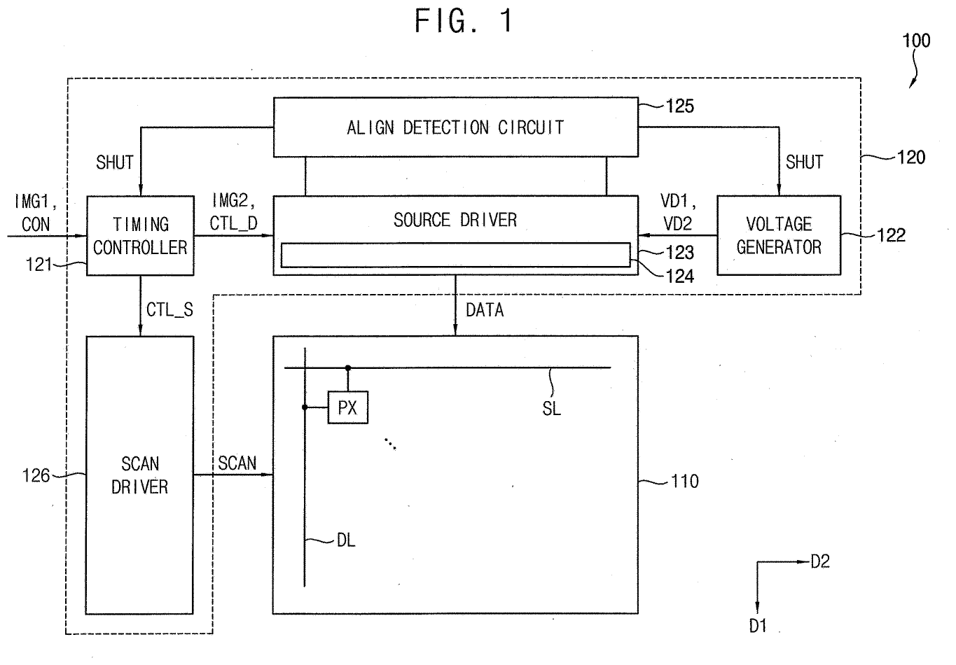

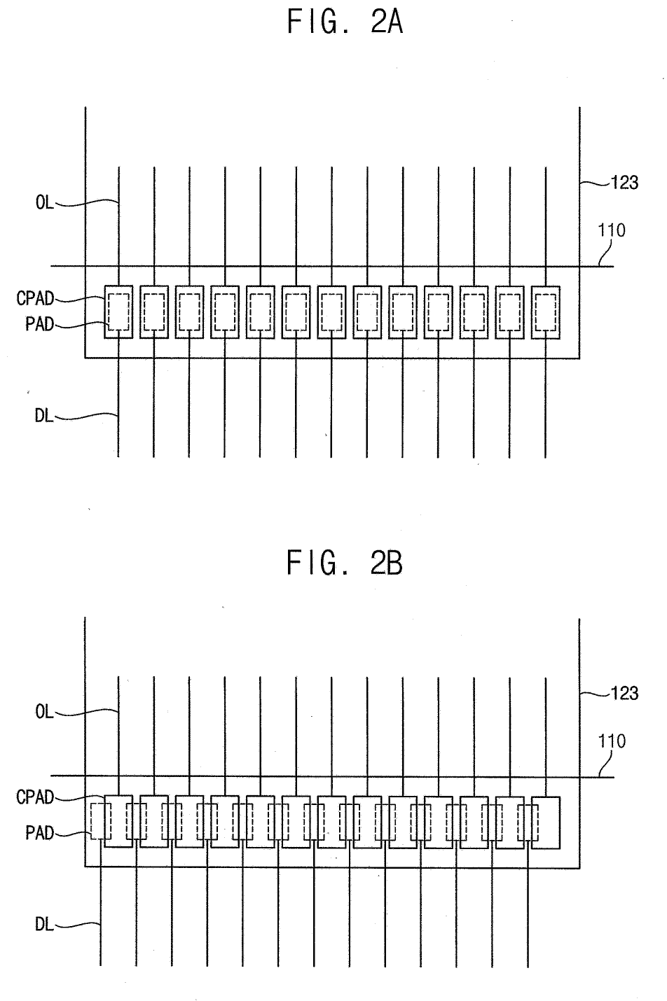

FIG. 1 is a block diagram illustrating a display device according to an exemplary embodiment, and FIGS. 2A and 2B are diagrams illustrating a display panel and a source driver included in the display device of FIG. 1.

Referring to FIG. 1, an exemplary embodiment of the display device 100 may include a display panel 110 and a display panel driving circuit 120. The display panel driving circuit 120 may include a timing controller 121, a voltage generator 122, a source driver 123, an alignment detection circuit 125, and a scan driver 126.

The display panel 110 may include a plurality of data lines DL, a plurality of scan lines SL, and a plurality of pixels PX. The data lines DL may extend in the first direction D1 and may be arranged in the second direction D2 perpendicular to the first direction D1. The scan lines SL may extend in the second direction D2 and may be arranged in the first direction D1. In one exemplary embodiment, for example, the first direction D1 may be parallel to a short side of the display panel 110, and the second direction D2 may be parallel to a long side of the display panel 110. The pixels PX may be disposed in a region where the data lines DL intersect the scan lines SL. The pixels PX may respond to a scan signal SCAN supplied through the scan lines SL to emit light corresponding to a data signal DATA supplied through the data lines DL. In an exemplary embodiment, the pixels PX may include a thin film transistor electrically connected to the data line DL and the scan line SL, a storage capacitor connected to the thin film transistor, a driving transistor connected to the storage capacitor, and an organic light emitting diode connected to the driving transistor. In such an embodiment, the display panel 110 may be an organic light emitting display panel, and the display device 100 may be an organic light emitting display device. In an alternative exemplary embodiment, the pixels PX may include a thin film transistor electrically connected to the scan line SL and the data line DL, and a liquid crystal capacitor and a storage capacitor connected to the thin film transistor. In such an embodiment, the display panel 110 may be a liquid crystal display panel, and the display device 100 may be a liquid crystal display device.

The display panel 110 may include a display region and a non-display region. Pixels PX are disposed or defined in the display region, and an image may be displayed based on the data signal DATA supplied through the data line DL. A circuit portion or the like may be disposed in the non-display region to drive the pixels PX. In such an embodiment, a pad portion including a plurality of pads connected to the data lines DL may be disposed or defined in the non-display region of the display panel 110. The pads may be connected to the source driver 123 for supplying the data signal DATA.

The timing controller 121 may receive first image data IMG1 and a control signal CON from an external device. The timing controller 121 may convert the first image data IMG1 supplied from the external device into second image data IMG2. The timing controller 121 may apply an algorithm for correcting image quality of the first image data IMG1 to convert the first image data IMG1 into the second image data IMG2, and supply the second image data IMG2 to the source driver 123. The timing controller 121 may, based on the control signal CON, generate a scan control signal CTL_S and a data control signal CTL_D to control a driving timing of the second image data IMG2. In one exemplary embodiment, for example, the scan control signal CTL_S may include a vertical start signal and at least one scan clock signal, and the data control signal CTL_D may include a horizontal start signal and a horizontal synchronization signal. The timing controller 121 may supply the scan control signal CTL_S to the scan driver 126, and provide the data control signal CTL_D to the source driver 123.

In an exemplary embodiment, the voltage generator 122 may receive a direct-current (“DC”) power from an outside to generate a plurality of voltages used for operating the display panel 110. In one exemplary embodiment, for example, the voltage generator 122 may generate an on-voltage and an off-voltage that are supplied to the scan driver 126, and a data driving voltage, a first detection voltage VD1 and a second detection voltage VD2 that are supplied to the source driver 123. The voltage generator 122 may generate the on-voltage and the off-voltage to supply the on-voltage and the off-voltage to the scan driver 126. The on-voltage and the off-voltage may be driving voltages to generate a scan signal SCAN applied to the scan line SL. The voltage generator 122 may generate the data driving voltage to supply the data driving voltage to the source driver 123. In one exemplary embodiment, for example, the voltage generator 122 may generate an analog power supply voltage, a digital power supply voltage, or the like to supply the generated voltage to the source driver 123. The analog power supply voltage and the digital power supply voltage may be driving voltages to generate a data signal DATA applied to the data line DL. In such an embodiment, the voltage generator 122 may supply the first detection voltage VD1 and the second detection voltage VD2 to the source driver 123 during an inspection process. Herein, the voltage level of the second detection voltage VD2 may be lower than the voltage level of the first detection voltage VD1. The first detection voltage VD1 and the second detection voltage VD2 may be voltages provided to the detection circuit 124 of the source driver 123 to detect whether the source driver 123 are misaligned with the display panel 110.

The source driver 123 may generate the data signal DATA based on the second image data IMG2 and the data control signal CTL_D supplied from the timing controller 121. The source driver 123 may convert the second image data IMG2, which is digital image data, into analog image data, and generate the data signal DATA based on the analog image data.

The source driver 123 may be implemented as a chip-on-film (“COF”) including an integrated circuit (“IC”) and a flexible printed circuit board (“FPCB”) on which the IC is mounted. Alternatively, the source driver 123 may be implemented as an IC to be mounted on the non-display region of the display panel 110 as a chip-on-glass (“COG”) type. The source driver 123 may include a plurality of output lines.

Referring to FIG. 2A, one end of the output line OL may be implemented as a connection pad CPAD to be connected to the pad portion in the non-display region of the display panel 110. The connection pads CPAD of the output lines OL may be connected to the pads PAD of the pad portions of the display panel, respectively. As shown in FIG. 2B, when the source driver 123 and the pads PAD of the display panel 110 are misaligned, a short may occur between the output lines OL of the source driver 123 or between the pads PAD of the display panel 110 such that the screen abnormality may occur or the display panel 110 may be damaged. In an exemplary embodiment of the invention, the display device 100 includes the source driver 123 including the detection circuit and the alignment detection circuit 125, such that the misalignment between the output lines of the source driver 123 and the pad portion of the display panel 110 may be detected during the inspection process.

In an exemplary embodiment, the source driver 123 may include a detection circuit 124. The detection circuit 124 may connect the buffer supplied with the data signal DATA to the output lines, or connect the first detection line and the second detection line to the output lines. The detection circuit 124 may connect the buffer and the output lines when the display device 100 is driven, such that the data signal DATA may be supplied to the pad portion of the display panel 110 through the output lines. The detection circuit 124 may connect the first detection line and the second detection line to the output lines during the inspection process, such that the misalignment between the output lines of the source driver 123 and the pad portion of the display panel 110 may be detected. In such an embodiment, the detection circuit 124 may include a first dummy amplifier, a second dummy amplifier, a first detection line, and a second detection line. The first dummy amplifier may receive the first detection voltage VD1 supplied from the voltage generator 122 to supply the first detection voltage VD1 to the first detection line. The second dummy amplifier may receive a second detection voltage VD2 supplied from the voltage generator 122 to supply the second detection voltage VD2 to the second detection line. The first detection line may be connected to a part of the output lines, and the second detection line may be connected to the rest of the output lines. In one exemplary embodiment, for example, The first detection line may be connected to a (2n−1)-th output line, and the second detection line may be connected to a (2n)-th output line. The (2n−1)-th output line may supply the first detection voltage VD1 supplied through the first detection line to the (2n−1)-th pad of the display panel 110, and the (2n)-th output line may supply the second detection voltage VD2 supplied through the second detection line to the (2n)-th pad of the display panel 110. However, when the output lines of the source driver 123 are misaligned with the pads of the display panel 110, the second detection voltage VD2 may be supplied to the (2n−1)-th pad, or the first detection voltage VD1 may be supplied to the (2n)-th pad.

The alignment detection circuit 125 may include a detection capacitor and a voltage detection circuit. The detection capacitor may be connected between the first detection line and the second detection line. The sensing capacitor may include a first electrode and a second electrode. When the output lines of the source driver 123 are normally aligned with the pads of the display panel 110, a voltage having a predetermined value may be applied to the first electrode and the second electrode of the detection capacitor. However, when the output lines of the source driver 123 are misaligned with the pads of the display panel, a voltage level of the voltage applied to the first electrode and the second electrode of the detection capacitor may be changed. The voltage detection circuit may be connected to one end of the detection capacitor to detect a voltage of the detection capacitor. In an exemplary embodiment, the voltage detection circuit may be connected to the first electrode of the detection capacitor to detect a voltage of the first electrode. In an alternative exemplary embodiment, the voltage detection circuit may be connected to the second electrode of the detection capacitor to detect a voltage of the second electrode. In one exemplary embodiment, for example, the voltage detection circuit may include a comparator. The comparator may compare the voltage applied to the first electrode of the detection capacitor with a first reference voltage, or compare the voltage applied to the second electrode of the detection capacitor with a second reference voltage. The voltage detection circuit may output a shutdown signal based on the comparison result of the comparator. In such an embodiment, when the voltage of the detection capacitor is higher than a reference voltage, the voltage detection circuit may output the shutdown signal SHUT. In an alternative exemplary embodiment, when the voltage of the detection capacitor is lower than the reference voltage, the voltage detection circuit may output the shutdown signal SHUT. In one exemplary embodiment, for example, the voltage detection circuit may supply the shutdown signal SHUT to the timing controller 121 to shut down the timing controller 121. Alternatively, the voltage detection circuit may supply the shutdown signal SHUT to the voltage generator 122 to shut down the voltage generator 122.

The scan driver 126 may generate a scan signal SCAN supplied to the pixels PX. The scan driver 126 may generate the scan signal SCAN based on the scan control signal CTL_S supplied from the timing controller 121, and sequentially supply the scan signal SCAN to the scan lines SL disposed on the display panel 110. The scan driver 126 may be provided or formed simultaneously with the transistors of the pixels PX to be mounted on the display panel 110 in the form of an amorphous silicon thin film transistor (“TFT”) gate driving unit circuit (“ASG”) or an oxide silicon TFT gate driving unit circuit (“OSG”). Alternatively, the scan driver 126 may be formed of or defined collectively by a plurality of driving chips to be mounted on the non-display region of the display panel 110 by a COG type. Alternatively, the scan driver 126 may be formed of or defined collectively by a plurality of driving chips in a form of a COF mounted on a FPCB to be connected to the display panel 110.

In an exemplary embodiment of the invention, as described above, the display device 100 includes the source driver 123 including the detection circuit 124 to supply the first detection voltage VD1 to the (2n−1)-th output line through the first detection line during the inspection process of the display device 100 and supply the second detection voltage VD2 to the (2n)-th output line through the second detection line, and the alignment detection circuit 125 including the detection capacitor connected between the first detection line and the second detection line and the voltage detection circuit to detect the voltage of the detection capacitor, such that the misalignment between the pads of the display panel 110 and the output lines of the source driver 123 may be detected. Accordingly, a bonding failure between the display panel 110 and the source driver 123 may be easily detected.

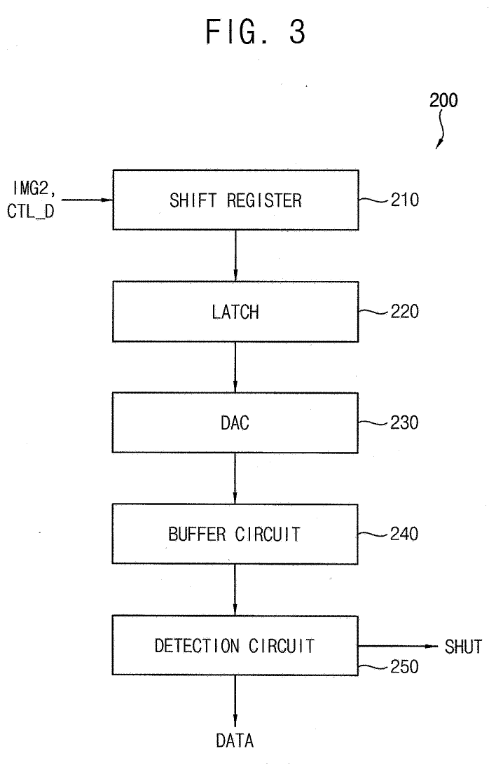

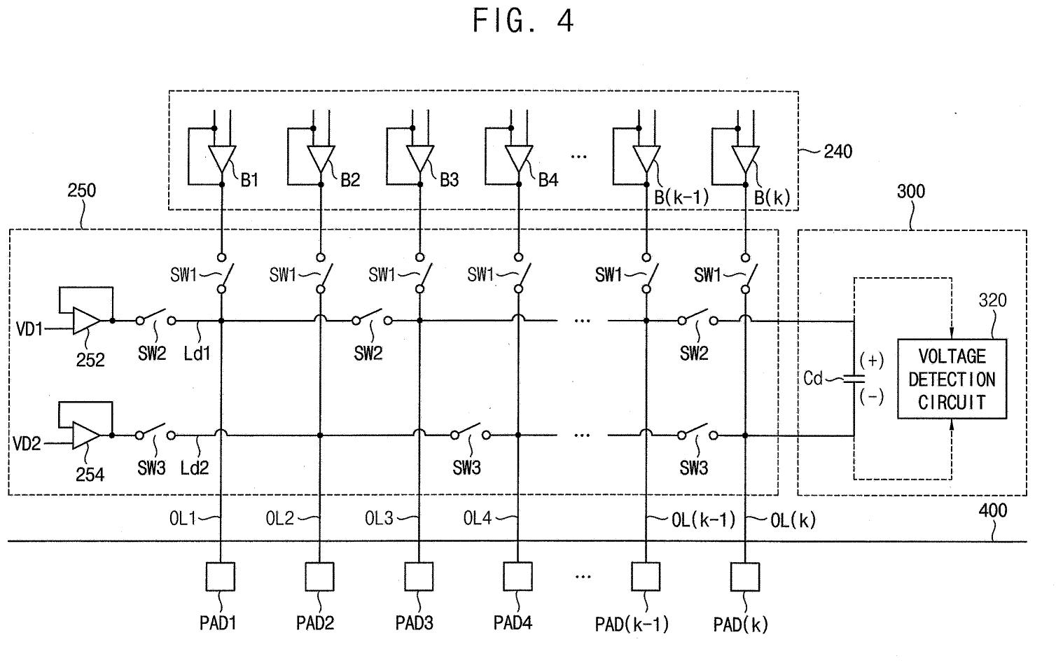

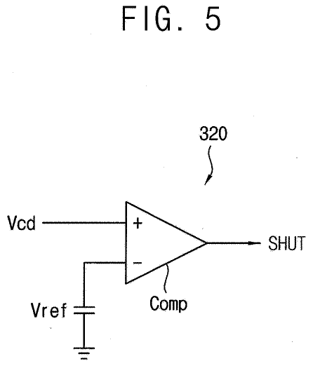

FIG. 3 is a block diagram illustrating a source driver included in the display device of FIG. 1, FIG. 4 is a diagram illustrating a detection circuit and an alignment detection circuit included in the source driver of FIG. 3, and FIG. 5 is a diagram illustrating an exemplary embodiment of the alignment detection circuit of FIG. 4.

Referring to FIG. 3, an exemplary embodiment of the source driver 200 may include a shift register 210, a latch 220, a digital-analog converter (referred to as DAC in FIG. 3) 230, a buffer circuit 240 and a detection circuit 250.

The shift register 210 may control an operation timing of the latch 220 based on the data control signal CTL_D supplied from the timing controller. The data control signal CTL_D may include a horizontal synchronization signal. The horizontal synchronization signal may be a signal having a predetermined cycle. The latch 220 may sample and store the second image data IMG2, which is digital image data, based on a shift order of the shift register 210. The latch 220 may output the stored second image data IMG2 to the digital-to-analog converter 230 in response to a latch signal.

The digital-analog converter 230 may convert the second image data IMG2, which is digital image data, into analog image data.

Referring to FIG. 4, the buffer circuit 240 may include a plurality of buffers B1, B2, . . . , B(k−1) and B(k). Each of the buffers B1, B2, . . . , B(k−1) and B(k) may generate data signal DATA based on the analog image data (here, k is a natural number of 2 or greater). Each of the buffers B1, B2, . . . , B(k−1) and B(k) may be implemented as an operational amplifier. Each of the buffers B1, B2, . . . , B(k−1) and B(k) may supply the data signal DATA to the output lines OL1, OL2, . . . , OL(k−1) and OL(k). In one exemplary embodiment, for example, the source driver 200 may include k buffers B1, B2, . . . , B(k−1) and B(k). The k buffers B1, B2, . . . , B(k−1), and B(k) may be connected to k output lines OL1, OL2, . . . , OL(k−1) and OL(k), respectively.

The detection circuit 250 may include output lines OL1, OL2, . . . , OL(k−1) and OL(k), a first switch SW1, a first dummy amplifier 252, a second dummy amplifier 254, a second switch SW2, and a third switch SW3.

One end of each of the output lines OL1, OL2, . . . , OL(k−1) and OL(k) may be connected to the first switch SW1, and the other end thereof may be connected to the pads PAD1, PAD2, . . . , PAD(k−1) and PAD(k) of the display panel 400. In an exemplary embodiment, where the source driver 200 includes k buffers B1, B2, . . . , B(k−1) and B(k), the detection circuit 250 may include k output lines OL1, OL2, . . . , OL(k−1) and OL(k). The k output lines OL1, OL2, . . . , OL(k−1) and OL(k) may be connected to k pads PAD1, PAD2, . . . , PAD(k−1) and PAD(k) in the non-display region, respectively.

The first switch SW1 may connect each of the output lines OL1, OL2, . . . , OL(k−1), and OL(k) to the buffers B1, B2, . . . , B(k−1) and B(k). The first switch SW1 may be turned on when the display device is driven. When the first switch SW1 is turned on, the output lines OL1, OL2, . . . , OL(k−1) and OL(k) are connected to the buffers B1, B2, . . . , B(k−1) and B(k), such that the data signal DATA outputted from the buffers B1, B2, . . . , B(k−1) and B(k) may be supplied to the output lines OL1, OL2, . . . , OL(K−1), and OL(k).

The first dummy amplifier 252 may supply the first detection voltage VD1 to the first detection line Ld1. The first dummy amplifier 252 may receive the first detection voltage VD1 from the voltage generator to supply the first detection voltage VD1 to the first detection line Ld1.

The second dummy amplifier 254 may supply the second detection voltage VD2 to the second detection line Ld2. The second dummy amplifier 254 may receive the second detection voltage VD2 from the voltage generator to supply the second detection voltage VD1 to the second detection line Ld2.

The second switch SW2 may connect the first detection line Ld1 to the (2n−1)-th output line OL1, OL3, . . . and OL(k−1) (here n is a natural number of 1 or greater). In such an embodiment, the second switch SW2 may connect the first detection line Ld1 and the odd-numbered output lines OL1, OL3, . . . , and OL(k−1). The second switch SW2 may be turned on during the inspection process for inspecting the bonding between the display panel 400 and the source driver 200. When the second switch SW2 is turned on, the first detection line Ld1 is connected to the (2n−1)-th output line OL1, OL3, . . . , and OL(k−1), such that the first detection voltage VD1 may be supplied.

The third switch SW3 may connect the second detection line Ld2 to the (2n)-th output line OL2, OL4, . . . , and OL(k). In such an embodiment, the third switch SW3 may connect the second detection line Ld2 to the even-numbered output lines OL2, OL4, . . . , and OL(k). The third switch SW3 may be turned on during the inspection process for inspecting the bonding between the display panel 400 and the source driver 200. When the third switch SW3 is turned on, the second detection line Ld2 is connected to the (2n)-th output line OL2, OL4, . . . , and OL(k), such that the second detection voltage VD2 may be supplied.

One end of the source driver 200 may be connected to the pads PAD1, PAD2, . . . , PAD(k−1), and PAD(k) of the display panel 400, and the other end of the source driver 200 may be connected to the FPCB. In an exemplary embodiment, where the source driver 200 is implemented as a COF, one end of the film, on which the IC is mounted, may be connected to the pads PAD1, PAD2, . . . , PAD(k−1) and PAD(k) of the display panel 400, and the other end of the film may be connected to a FPCB. In an alternative exemplary embodiment, where the source driver 200 is implemented as a COG, one end of the IC may be connected to the pads PAD1, PAD2, . . . , PAD(k−1) and PAD(k) of the display panel 400, and the other end of the IC may be connected to a printed circuit board. The other end of the PCB may be connected to a FPCB.

In an exemplary embodiment, the alignment detection circuit 300 may include a detection capacitor Cd and a voltage detection circuit 320.

The detection capacitor Cd may be connected between the first detection line Ld1 and the second detection line Ld2. In one exemplary embodiment, for example, the detection capacitor Cd may include a first electrode (+) connected to the first detection line Ld1, and a second electrode (−) connected to the second detection line Ld2. The detection capacitor Cd may store a voltage corresponding to a difference between a voltage applied to the first electrode (+) and a voltage applied to the second electrode (−).

The voltage detection circuit 320 may be connected to one end of the detection capacitor Cd. The voltage detection circuit 320 may be connected to the first electrode (+) or the second electrode (−) of the detection capacitor Cd. Referring to FIG. 5, the voltage detection circuit 320 may include a comparator Comp to compare a voltage Vcd of the detection capacitor Cd with a reference voltage Vref. In an exemplary embodiment, the voltage detection circuit 320 may be connected to the first electrode (+) of the detection capacitor Cd. In such an embodiment, a voltage having a positive value may be applied to the first electrode (+), and the voltage detection circuit 320 may compare the reference voltage Vref having a positive value with the voltage of the first electrode (+). In such an embodiment, the voltage detection circuit 320 may output the shutdown signal SHUT when the voltage of the first electrode (+) is lower than the reference voltage Vref. In an alternative exemplary embodiment, the voltage detection circuit 320 may be connected to the second electrode (−) of the detection capacitor Cd. In such an embodiment, a voltage having a negative value may be applied to the second electrode (−), and the voltage detection circuit 320 may compare the reference voltage Vref having the negative value with the voltage of the second electrode (−). In such an embodiment, the voltage detection circuit 320 may output the shutdown signal SHUT when the voltage of the second electrode (−) is higher than the reference voltage Vref.

The alignment detection circuit 300 may be mounted on the FPCB connected to the source driver 200. The detection capacitor Cd and the voltage detection circuit 320 may be implemented as a driving chip mounted on the FPCB to be connected to the source driver 200.

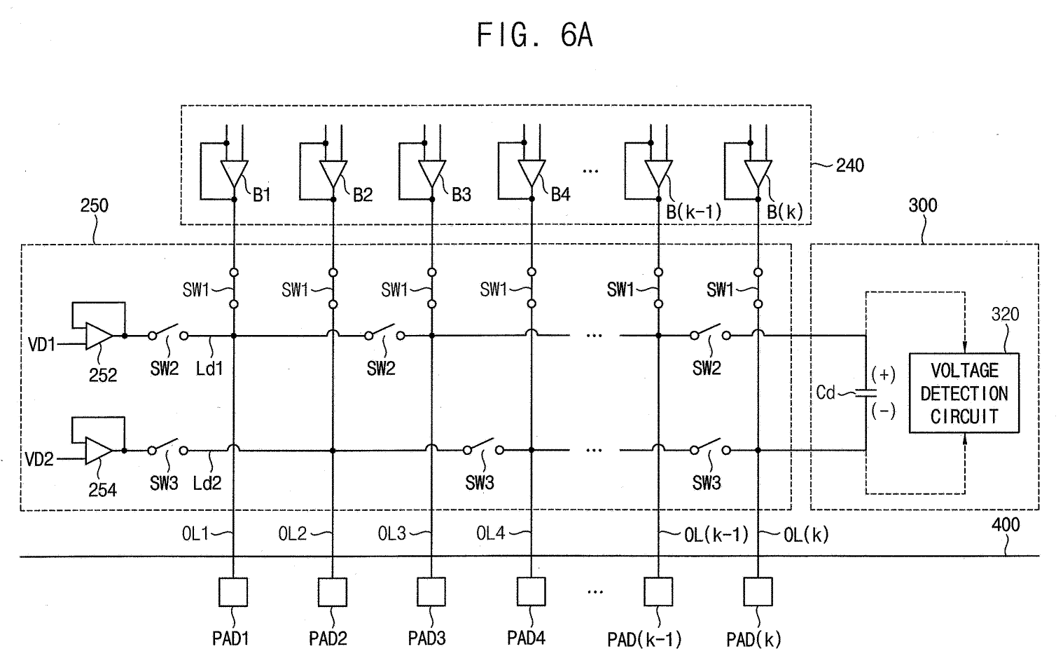

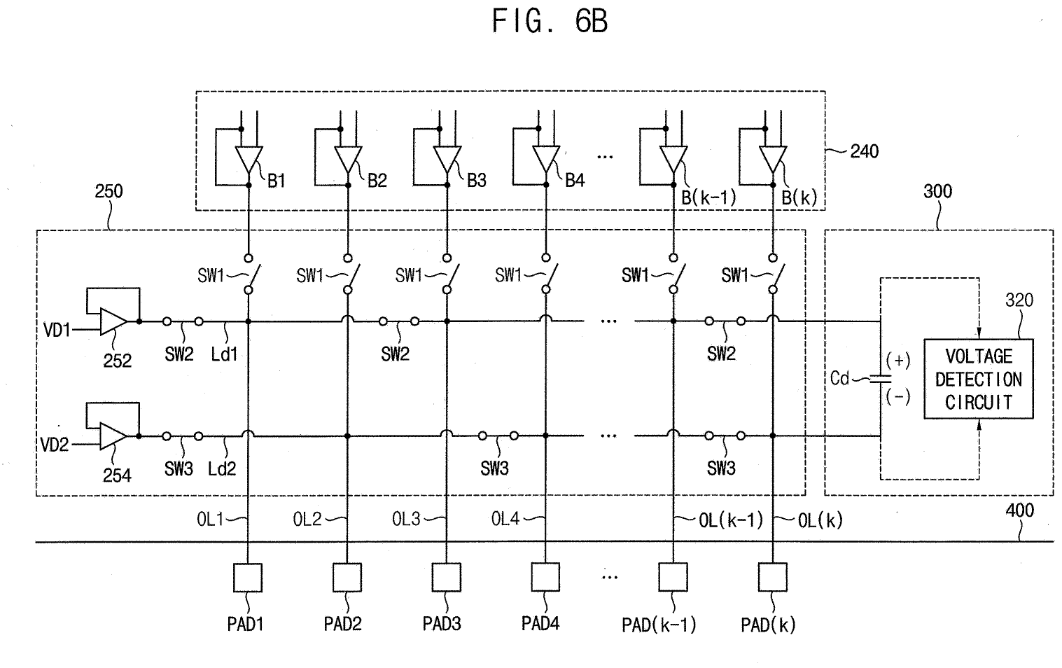

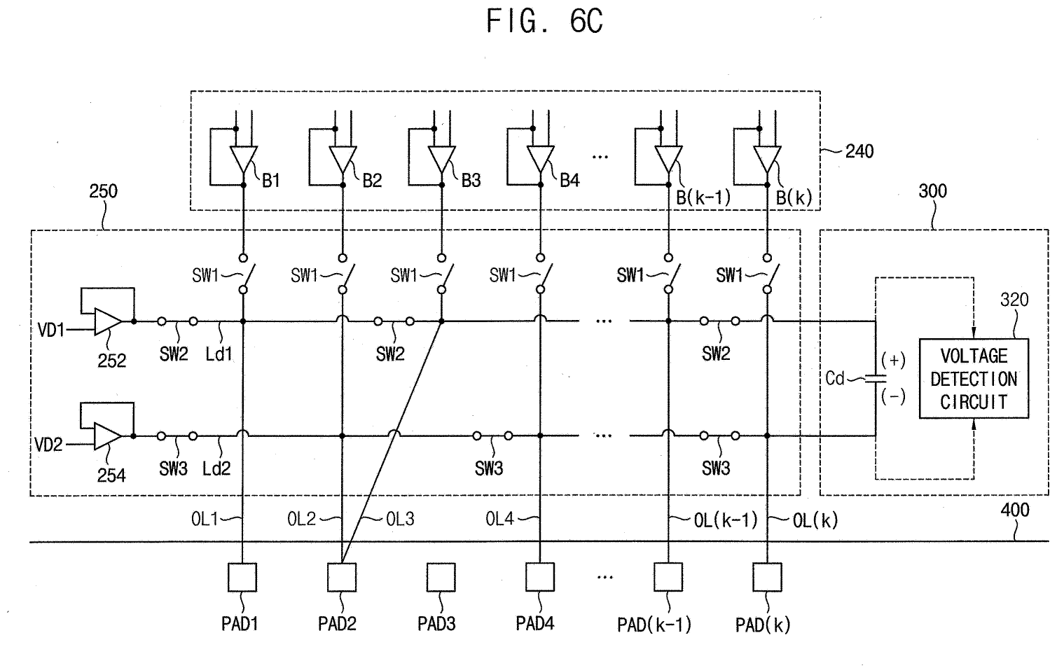

FIGS. 6A to 6C are diagrams for describing operations of the detection circuit and the alignment detection circuit of FIG. 4.

Referring to FIG. 6A, when the display device is driven, the first switch SW1 may be turned on, and the second switch SW2 and the third switch SW3 may be turned off. When the first switch SW1 is turned on, the buffers B1, B2, . . . , B(k−1) and B(k) of the buffer circuit 240 may be connected to the output lines OL1, OL2, . . . , OL(k−1) and OL(k), respectively. Each of the buffers B1, B2, . . . , B(k−1) and B(k) may supply the data signal DATA to the pads PAD1, PAD2, . . . , PAD(k−1) and PAD (k) connected to the data lines of the display panel 400 through the output lines OL1, OL2, . . . , OL(k−1) and OL(k). When the second switch SW2 is turned off, the first detection line Ld1 may not be connected to the output lines OL1, OL2, . . . , OL(k−1) and OL(k). In such an embodiment, when the third switch SW3 is turned off, the second detection line Ld2 may not be connected to the output lines OL1, OL2, OL(k−1), and OL(k).

Referring to FIG. 6B, during an inspection process for inspecting the bonding between the display panel 400 and the source driver 200, the first switch SW1 may be turned off, and the second switch SW2 and the third switch SW3 may be turned on. When the first switch SW1 is turned off, the buffers B1, B2, . . . , B(k−1) and B(k) of the buffer circuit 240 may not be connected to the output lines OL1, OL2, . . . , OL(k−1) and OL(k). When the second switch SW2 is turned on, the first detection line Ld1 may be connected to the (2n−1)-th output line OL1, OL3, . . . , and OL(k−1) of the output lines OL1, OL2, . . . , OL(k−1), and OL(k). The first detection voltage VD1 may be supplied to the (2n−1)-th output line OL1, OL3, . . . , and OL(k−1) through the first detection line Ld1. When the third switch SW3 is turned on, the second detection line Ld2 may be connected to the (2n)-th output line OL2, OL4, . . . , and OL(k) of the output lines OL1, OL2, . . . , OL(k−1) and OL(k). The second detection voltage VD2 may be supplied to the (2n)-th output line OL2, OL4, . . . , and OL(k) through the second detection line Ld2.

The voltage of the first detection line Ld1 may be applied to the first electrode (+) of the detection capacitor Cd, and the voltage of the second detection line Ld2 may be applied to the second electrode (−). Herein, the voltage applied to the first electrode (+) may have a positive value, and the voltage applied to the second electrode (−) may have a negative value. The voltage detection circuit 320 may be connected to the first electrode (+) or the second electrode (−) of the detection capacitor Cd. When the voltage detection circuit 320 is connected to the first electrode (+) of the detection capacitor Cd, the voltage detection circuit 320 may compare the voltage of the first electrode (+) of the detection capacitor Cd with the first reference voltage Vref. When the voltage detection circuit 320 is connected to the second electrode (−) of the detection capacitor Cd, the voltage detection circuit 320 may compare the voltage of the second electrode (−) of the detection capacitor Cd with a second reference voltage Vref. As shown in FIG. 5B, when the output lines OL1, OL2, . . . , OL(k−1) and OL(k) of the source driver 200 are normally bonded with the pads PAD1, PAD2, PAD(k−1) and PAD(k) of the display panel 400, the voltage detection circuit 320 may not output the shutdown signal SHUT. When the voltage of the first electrode (+) is equal to the first reference voltage Vref or higher than the first reference voltage Vref, the voltage detection circuit 320 may not output the shutdown signal SHUT. When the voltage of the second electrode (−) is equal to the second reference voltage Vref or lower than the second reference voltage Vref, the voltage detection circuit 320 may not output the shutdown signal SHUT.

Referring to FIG. 6C, the output lines OL1, OL2, . . . , OL(k−1), and OL(k) of the source driver 200 may be misaligned and bonded with the pads PAD1, PAD2, . . . , PAD(k−1), and PAD(k) of the display panel 400. As shown in FIG. 5C, when the third output line OL3 of the source driver 200 is bonded to the second pad PAD2 of the display panel 400, the voltage supplied to the first electrode (+) of the detection capacitor Cd may be decreased, and the voltage supplied to the second electrode (−) may be increased, such that the voltage level of the voltages applied to the first electrode (+) and the second electrode (−) of the detection capacitor Cd may be changed. When the voltage detection circuit 320 is connected to the first electrode (+) of the detection capacitor Cd, the voltage detection circuit 320 may compare the voltage of the first electrode (+) with the first reference voltage Vref, and when the voltage of the first electrode (+) is lower than the first reference voltage Vref, the voltage detection circuit 320 may output the shutdown signal SHUT. When the voltage detection circuit 320 is connected to the second electrode (−) of the detection capacitor Cd, the voltage detection circuit 320 may compare the voltage of the second electrode (−) with the second reference voltage Vref, and when the voltage of the second electrode (−) is higher than the second reference voltage Vref, the voltage detection circuit 320 may output the shutdown signal SHUT. FIG. 6C shows the short-circuited case caused by the connection between the output lines (i.e., the second output line OL2 and the third output line OL3) of the source driver 200 and the third output line OL3 due to the misalignment between the source driver 200 and the display panel 400. However, there may be a short-circuit when the pads PAD1, PAD2, . . . , PAD(k−1), and PAD(k) of the display panel 400 are connected by the misalignment between the source driver 200 and the display panel 400 (see FIG. 2B). Even in such a case, the voltages applied to the first detection line Ld1 and the second detection line Ld2 may be changed so that the voltage level of the voltages applied to the first electrode (+) and the second electrode (−) of the detection capacitor Cd may be changed.

In an exemplary embodiment of the invention, as described above, the source driver 200 and the alignment detection circuit 300 are configured to supply, during the inspection process of the display device, the first detection voltage DV1 to the (2n−1)-th output line OL1, OL3, . . . , and OL(k−1) through the first detection line Ld1, supply the second detection voltage VD2 to the (2n)-th output line OL2, . . . , and OL(k) through the second detection line Ld2, and detect the voltage of the detection capacitor Cd connected between the first detection line Ld1 and the second detection line Ld2, such that the misalignment between the pads of the display panel 400 and the output lines OL1, OL2, . . . , OL(k−1), and OL(k) of the source driver 200 may be detected. Accordingly, in such an embodiment, the bonding failure between the display panel 400 and the source driver 200 may be easily detected.

Exemplary embodiments of the invention may be applied to an electronic device including a display device, e.g., a television, a computer monitor, a laptop computer, a digital camera, a cellular phone, a smart phone, a smart pad, a tablet personal computer (“PC”), a personal digital assistant (“PDA”), a portable multimedia player (“PMP”), an MP3 player, a car navigation system, a video phone, a head mounted display (“HMD”) device, etc.

The foregoing is illustrative of an exemplary embodiment and is not to be construed as limiting thereof. Although a few exemplary embodiments have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A display device comprising:
a display panel including a plurality of data lines and a plurality of pads connected to the data lines;
a source driver including:
a plurality of output lines connected to the pads, wherein the source driver supplies a data signal to the pads through the output lines; and
a detection circuit which selectively connects a first detection line and a second detection line to the output lines, wherein the first detection line is supplied with a first detection voltage and the second detection line is supplied with a second detection voltage; and
an alignment detection circuit including a detection capacitor connected between the first detection line and the second detection line, and a voltage detection circuit connected to an end of the detection capacitor, wherein the voltage detection circuit detects a voltage of the detection capacitor,
wherein the detection circuit connects an (2n−1)-th output line of the output lines to the first detection line, and connects an (2n)-th output line of the output lines to the second detection line, wherein n is a natural number of 1 or greater.

2. The display device of claim 1, wherein the source driver further includes:
a digital-to-analog converter which converts digital image data into analog image data; and
a buffer circuit including a plurality of buffers which generates the data signal based on the analog image data.

3. The display device of claim 2, wherein the detection circuit includes:
a first switch which connects the output line to the buffer;
a first dummy amplifier which supplies the first detection voltage to the first detection line;
a second dummy amplifier which supplies the second detection voltage having a voltage level lower than a voltage level of the first detection voltage to the second detection line;
a second switch which connects the first detection line to the (2n−1)-th output line; and
a third switch which connects the second detection line to the (2n)-th output line.

4. The display device of claim 3, wherein the detection circuit turns off the first switch and turns on the second switch and the third switch during an inspection process to detect whether the output lines are misaligned with the pads.

5. The display device of claim 3, wherein the detection circuit turns on the first switch and turns off the second switch and the third switch to transfer the data signal to the pads through the output line.

6. The display device of claim 1, wherein the voltage detection circuit includes a comparator which compares the voltage of the detection capacitor with a reference voltage.

7. The display device of claim 6, further comprising:
a timing controller which generates a control signal to control the source driver,
wherein the voltage detection circuit outputs a shutdown signal to shut down the timing controller based on a comparison result between the voltage of the detection capacitor and the reference voltage.

8. The display device of claim 6, further comprising:
a voltage generator which supplies the first detection voltage and the second detection voltage,
wherein the voltage detection circuit outputs a shutdown signal to shut down the voltage generator based on a comparison result between the voltage of the detection capacitor and the reference voltage.

9. The display device of claim 1, wherein
an end of the source driver is connected to the pads of the display panel, and
an opposite end of the source driver is connected to a printed circuit board.

10. The display device of claim 9, wherein the alignment detection circuit is disposed on the printed circuit board.

11. A display panel driving device comprising:
a source driver including:
a plurality of output lines through which a data signal is transmitted; and
a detection circuit which selectively connects a first detection line and a second detection line to the output lines, wherein the first detection line transmits a first detection voltage and a second detection line transmits a second detection voltage; and
an alignment detection circuit including a detection capacitor connected between the first detection line and the second detection line, and a voltage detection circuit connected to an end of the detection capacitor, wherein the voltage detection circuit detects a voltage of the detection capacitor,
wherein the detection circuit connects a (2n−1)-th output line of the output lines to the first detection line, and connects a (2n)-th output line of the output lines to the second detection line, wherein n is a natural number of 1 or greater.

12. The display panel driving device of claim 11, wherein the source driver further includes:
a digital-to-analog converter which converts digital image data into analog image data; and
a buffer circuit including a plurality of buffers which generates the data signal based on the analog image data.

13. The display panel driving device of claim 11, wherein the detection circuit includes:
a first switch which connects the output lines to the buffer;
a first dummy amplifier which supplies the first detection voltage to the first detection line;
a second dummy amplifier which supplies the second detection voltage having a voltage level lower than a voltage level of the first detection voltage to the second detection line;
a second switch which connects the first detection line to the (2n−1)-th output line; and
a third switch which connects the second detection line to the (2n)-th output line.

14. The display panel driving device of claim 13, wherein the detection circuit turns off the first switch and turns on the second switch and the third switch during an inspection process to detect whether the output lines are misaligned with a plurality of pads of a display panel.

15. The display panel driving device of claim 13, wherein the detection circuit turns on the first switch and turns off the second switch and the third switch to output the data signal through the output lines.

16. The display panel driving device of claim 11, wherein the voltage detection circuit includes a comparator which compares the voltage of the detection capacitor with a reference voltage.

17. The display panel driving device of claim 16, further comprising:
a timing controller which generates a control signal to control the source driver,
wherein the voltage detection circuit outputs a shutdown signal to shut down the timing controller based on a comparison result between the voltage of the detection capacitor and the reference voltage.

18. The display panel driving device of claim 16, further comprising:
a voltage generator which generates the first detection voltage and the second detection voltage,
wherein the voltage detection circuit outputs a shutdown signal to shut down the voltage generator based on a comparison result between the voltage of the detection capacitor and the reference voltage.

19. The display panel driving device of claim 11, wherein
an end of the source driver is connected to the pads of the display panel, and
an opposite end of the source driver is connected to a printed circuit board.

20. The display panel driving device of claim 19, wherein the alignment detection circuit is disposed on the printed circuit board.
